(19) United States
(12) Patent Application Publication
(10) Pub. No.: US 2020/0393152 A1
(43) Pub. Date: Dec. 17, 2020

(54) ADAPTIVE, RESPONSIVE, DYNAMIC BUILDING VENTILATION CONTROL SYSTEM

(71) Applicant: Natural Air E-Controls, LLC, Lake Wells, FL (US)

(72) Inventors: Maurice A. Ramirez, Lake Wells, FL (US); Michael V. Bivins, Orlando, FL (US); Jonathan Carson, Lake Wales, FL (US)

(21) Appl. No.: 16/883,558

(22) Filed: May 26, 2020

Related U.S. Application Data
(60) Provisional application No. 62/852,967, filed on May 24, 2019.
(60) Provisional application No. 62/852,968, filed on May 24, 2019.

(51) Int. Cl. F24F 11/30; F24F 11/00; F24F 11/46; F24F 11/34; F24F 11/64; F24F 11/65; F24F 11/80; G05B 19/042

(52) U.S. Cl. CPC F24F 11/30; F24F 11/0001; F24F 11/0008; F24F 11/46; F24F 2140/40; F24F 11/64; F24F 11/65; F24F 11/80; G05B 19/042; F24F 11/34

(57) ABSTRACT

Examples herein describe systems and methods for dynamic building ventilation control. A control system can include a controller that receives information from the indoor and outdoor sensor packages. The control system can compare indoor and outdoor air quality using information from the indoor and outdoor sensor packages. The controller can also determine a current operational state of a heating, ventilation, and air conditioning (“HVAC”) system, such as heating, cooling, and fan status. Based on the air quality comparison and current operational state, the controller can open a first damper and closing a second damper to change ventilation of a building.

### CROSS-REFERENCE TO RELATED APPLICATIONS

This non-provisional application claims priority to provisional application No. 62/852,967, titled “Adaptive, Responsive, Dynamic Building Ventilation Control and Equipment Monitor,” filed May 24, 2019, and also claims priority to provisional application No. 62/852,968, titled “HVAC Compressor and Heat Pump Monitoring System with Misting System for Condenser Coils,” filed May 24, 2019, both of which are incorporated by reference in their entireties.

### BACKGROUND

Limiting energy consumption while maximizing both indoor and outdoor air quality is a worldwide call to action. The effects of indoor air pollution (“IAP”) on indoor air quality (“IAQ”) are major health concerns recognized by organizations such as the World Health Organization (“WHO”). U.S. Health & Human Services (“HHS”), U.S. Dept. of Energy, National Renewable Energy Laboratories (“NREL”), and U.S. Environmental Protection Agency (“EPA”), and in many non-governmental studies. Governmental and non-governmental organizations across the globe, along with consumers and healthcare professionals, recognize the health risks associated with indoor air pollution and poor indoor air quality. According to the EPA, indoor air can be over 10 times more polluted than outdoor air. Contaminants such as formaldehyde, volatile organic compounds (“VOCs”), and radon can accumulate in poorly ventilated homes and buildings. Excess moisture generated within the home also needs to be removed before high humidity levels lead to physical damage or mold growth within the home. The Heating Ventilating and Air Conditioning (“HVAC”) industry, along with their customers, have struggled to find a balance between energy efficiency and adequate ventilation.

All of these same experts agree that exchange of indoor air with outdoor air should be controlled by a whole-building ventilation system. The US Dept. of Energy Office of Energy Efficiency and Renewable Energy (“OEERE”) reminds builders and homeowners that all homes need ventilation-the exchange of indoor air with outdoor air-to reduce indoor pollutants, moisture, and unpleasant odors. To ensure adequate ventilation, the American Society of Heating, Refrigerating and Air-Conditioning Engineers, Inc. (“ASHRAE”) standard 62.2-2016 states that the living area of a home should be ventilated at a minimum rate of 0.35 air changes per hour or 15 cubic feet per minute (cfin) per person, whichever is greater. These standards are being expanded to include air dilution to reduce the risk of contracting air bourne infection.

Ventilation is also a significant factor in energy usage. Energy necessary for heating and cooling accounts for nearly 50% of the total energy cost for homes and other small structures. To counter this rising expense, the “envelope” of buildings has become increasingly airtight. United States and international building codes mandate that new and remodeled structures be constructed with both a “tight envelope” and a code-compliant, whole-building ventilation system. In effect, buildings should be tightly sealed to reduce energy loss and minimize infiltration of outside pollutants, yet ventilated sufficiently to maximize indoor air quality.

Whole-building ventilation systems are intended to provide an effective means of striking a balance between air quality and air exchange in a controlled manner. However, if a structure is too airtight, then the intended benefit of improved indoor air quality possible by ventilation is diminished. Current systems do not accomplish this balance without adversely impacting structural components or increasing the energy demands needed to run the system in a tightly seal building.

A common point of confusion is the difference between Whole-Building Ventilation and Whole-Building Fan Cooling/Heating. Whole-Building ventilation can be the replacement of a preset amount of stale indoor air with outdoor air by mechanical ventilation as specified by ASHRAE 62.2. The typical ASHRAE compliant whole building ventilation system ventilates at 30 cfm to 130 cfm. The US Department of Energy estimates that Whole-Building ventilation causes a 10% to 40% loss of HVAC system energy efficiency. Then there is Whole-Building Fan Cooling/Heating, which is defined by the DOE as the use of a fan to draw cool outdoor air inside through open windows or dampers and exhaust hot indoor air through the attic to the outside. The typical DOE compliant whole building fan cooling/heating system ventilates at 2000 to 5000 cfm. The US Department of Energy estimates that Whole-Building Fan Cooling/Heating yields a 20% to 30% energy savings compared to a conventional HVAC system.

Whole-Building ventilation systems, Energy Recovery Ventilators and ASHRAE compliant HVAC installations are requirements designed primarily to improve indoor air quality via inflow of external air and only secondarily to minimize the negative impact of that ventilation on HVAC efficiency and energy costs.

The U.S. EPA has raised the concern that the introduction of high humidity outside air into a building for the purpose of whole building ventilation or whole building fan cooling/heating promotes the growth of mold and mildew within the building ventilation system as well as the entire structure. In addition to the inherent limitations of both Whole-Building Ventilation and Whole-Building Fan Cooling/Heating, the utility of each system is further limited by regional climate and regional humidity.

Therefore, a need exists for an improved dynamic building ventilation control system that can minimize energy consumption while maximizing indoor air quality.

### SUMMARY

Examples described herein include systems and methods for whole-building dynamic ventilation control. Example systems can dynamically adjust ventilation is to expel stale inside air and ventilate with fresh outside air. This can be done primarily at times when outdoor air temperature and humidity can be used to help heat or cool the interior, while minimizing impact on energy efficiency. In one example, the existing HVAC system can be modified to draw in fresh outside air when needed and condition and distribute the outside air throughout the structure. This can yield a climate controlled indoor space that strikes a balance between indoor air quality, occupant comfort, energy efficiency, and energy bills, in an example. In one example, an HVAC control system can provide the minimum ASHRAE ventilation for a given time period.

In an example, the system can limit ventilation requests to periods when indoor air quality is worse than outdoor air quality as measured by a wide variety of factors including but not limited to Volatile Organic Compounds (“VOC's”), air pollutant gasses, off gasses, combustion gasses, ozone, particulates, humidity and temperature. Given the wide variety of residential and small commercial building HVAC components (thermostats, air handlers, heaters, heat pumps, cooling compressors, etc.) on the market, a control system can function to carry, interpret and modify control signals between existing and future HVAC components in the marketplace.

In one example, the dynamic ventilation control system can include a controller that includes a microprocessor board with memory and I/O connections, 24-volt AC to DC voltage converters, relays, a noise sensor, wireless communications interface, current sensors, and an evaporator coil temperature sensor. The system can also include a display unit that includes a touch screen module. This can allow a user to set parameters used by the controller, in an example. The system can also include sensor packages. The sensor packages can be used to determine indoor air quality and outdoor air quality (“OAQ”). These sensor packages can include a microprocessor board with memory and I/O connections, an air particle sensor array, a static pressure sensor, and a gas sensor array that contains a VOC sensor, an ozone and air pollutant sensor, a carbon monoxide and combustion gas sensor, a temperature sensor, a humidity sensor, and a radon sensor. Noise pollution sensors can also be used.

In one example, the controller receives IAQ information from the indoor sensor package and OAQ information from the outdoor sensor package. The sensor packages can provide normalized scores reflecting IAQ and OAQ, in an example. Alternatively, readings for air quality indicators, such as pollutant levels, can be sent for compilation by the controller.

The controller can make an air quality comparison based on the IAQ and OAQ information. Generally, the same types of information can be compared to determine whether IAQ is greater than or less than OAQ. The differential in air quality can help the controller determine whether to use indoor or outdoor air with the HVAC system.

The controller can also determine whether to use outdoor air based on the operating state of the HVAC system. The controller can receive a thermostat signal to know the operational state, in an example. If the HVAC is attempting to heat the building, then comparing outdoor air temperature to indoor air temperature can influence whether to use the outdoor air. The same is true is for cooling. If the outdoor air is cooler than the indoor air and the HVAC is attempting to cool, then outdoor air can be used. These can be subject to the IAQ and OAQ comparisons also.

Based on analysis of the indoor and outdoor air, the controller can issue damper commands to switch between using indoor and outdoor air in the HVAC system. In one example, the controller can generate a first damper command to close an indoor damper and open an outdoor damper of a building. The first damper command can be based on at least the air quality comparison favoring OAQ over IAQ and an outside air dewpoint being below indoor air temperature.

The controller can also receive a noise sensor input for detecting sirens and noise pollution. If the sirens are internal alarms, such as smoke detectors, the controller can open the dampers for outside ventilation, in an example. Similarly, outdoor noise can be detected and the controller can turn on white noise to prevent users from being subjected to loud outdoor sounds. In one example, sound barriers can erect over outside ventilation to prevent the outdoor noise from entering the building.

In summary, the dynamic ventilation control system can bean adaptive smart system that accomplishes this balance without adversely impacting structural components or increasing the energy demands needed to run the system in a tightly sealed building. Added to a standard high-efficiency HVAC system between the thermostat and the air handler, the smart control system along with spring return powered dampers and a barometric relief damper can provide indoor air and outdoor air responsive whole-building ventilation only when needed to optimize indoor air quality. Further energy efficiency can be accomplished with the addition of an Economizer and/or an Energy Recovery Ventilator under control of the control system.

In one example, the system can be installed in anew or pre-existing HVAC system that has the ability to draw air from outside the residence as well as recirculation inside air utilizing damper systems to switch between the two air sources.

In yet another example, a method for dynamic ventilation control can include receiving information from the indoor and outdoor sensor packages. Then, making an air quality comparison by, for example, using information from the indoor sensor package for indoor air quality and using information from the outdoor sensor package for outdoor air quality. Next, a current operational state of a heating, ventilation, and air conditioning (HVAC) system, such as heating, cooling, and fan status, would be determined. And based on the air quality comparison and current operational state, a first damper could be opened and a second damper closed to change ventilation of a building.

The examples summarized above can each be incorporated into a non-transitory, computer-readable medium having instructions that, when executed by a processor associated with a computing device, cause the processor to perform the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for performing dynamic building ventilation control.

FIG. 2 is a basic sequence diagram of a dynamic building ventilation control system.

FIG. 3 is an example block diagram of components for operation with a dynamic building ventilation control system.

FIG. 4A is an example schematic of components used in an example system.

FIG. 4B is an example schematic of components used in an example system.

FIG. 5 is an example illustration of components used in an example system.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

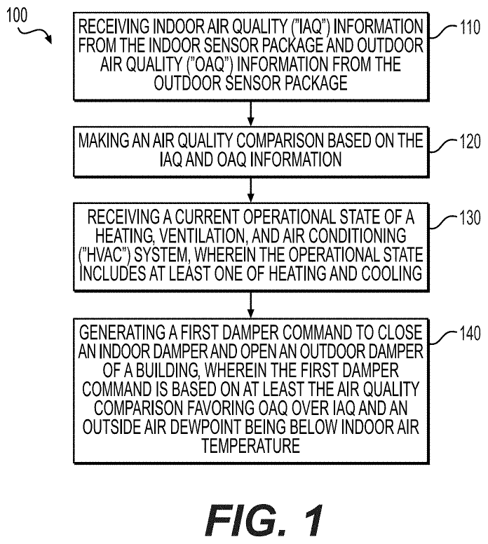

FIG. 1 is an example method 100 for whole-building dynamic ventilation control. At stage 110, a controller can receive air quality information from indoor and outdoor sensor packages. The sensor packages can be sensor arrays and in one example can include a processor for formatting the air quality information. The IAQ and OAQ information can be separately determined from indoor and outdoor sensor readings, respectively.

The IAQ and OAQ can each contain multiple different information types relevant to air quality. In one example, the sensor packages can include a microprocessor board with memory and I/O connections, an air particle sensor array, a static pressure sensor, and a gas sensor array that contains a VOC sensor. The sensor packages can further include an ozone and air pollutant sensor, a carbon monoxide and combustion gas sensor, a temperature sensor, a humidity sensor, and a radon sensor. Noise pollution sensors can also be incorporated.

The sensor arrays can be placed at an indoor air return, outdoor air intake, HVAC output duct, and an exhaust duct, in an example.

At stage 120, the controller can then make an air quality comparison that includes using information from the indoor sensor package for IAQ and using information from the outdoor sensor package for OAQ. The comparison can occur for each sensor type. The comparisons can include temperature, humidity, VOCs, sulfurous and nitrous pollutant gas levels, carbon dioxide, carbon monoxide, airborne particulates (e.g., dust, smoke, pollen) and environmental noise pollution. For example, indoor VOC can be compared to outdoor VOC, indoor combustion gas to outdoor combustion gas, indoor temperature to outdoor temperature, and so on. The different information type comparisons can be weighted according to which type of information is most important. Additionally, the difference amounts can be important to determining the differences between IAQ or OAQ. For example, if IAQ is worse than OAQ for several information types but OAQ shows a dangerous level of VOC, IAQ can still be considered superior to OAQ.

At stage 130, the controller can receive a current operational state of an HVAC system. The operational state can include at least one of heating, cooling, and fan status. The controller can receive an input from a thermostat in one example, allowing the controller to read the calls from the thermostat to the HVAC units. Whether the thermostat is calling for heating, cooling, or fan can be used as part of determining whether to supply inside or outsider air to the HVAC system. In one example, an opto-isolator on the HVAC control line can supply voltage to the controller. The supplied voltage can indicate the operational mode of the system.

At stage 140, the controller can, based on the air quality comparison and current operational state of the HVAC system, open a first damper and close a second damper to change the ventilation of a building. This can include generating a first damper command to use outside air when OAQ is greater than IAQ, or a second damper command to use indoor air when IAQ is greater than OAQ. For example, the first damper command can close an indoor damper and open an outdoor damper of a building, wherein the first damper command is based on at least the air quality comparison favoring OAQ over IAQ and an outside air dewpoint being below indoor air temperature.

The damper command can also take the operational state into account. For example, if the HVAC is cooling then the outdoor air may need to be below a threshold temperature, such as 10 degrees Fahrenheit above the thermostat temperature.

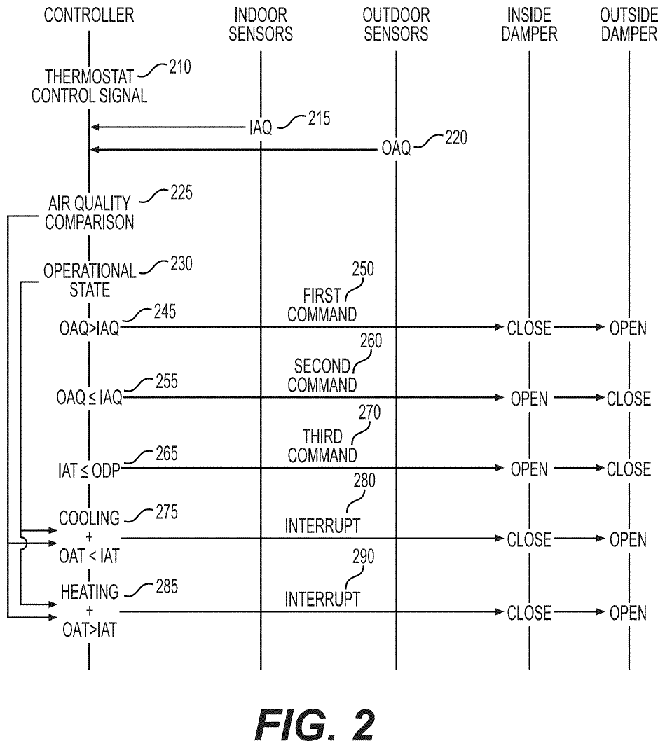

FIG. 2 illustrates an example sequence diagram with stages for dynamically controlling intake of an HVAC system. At stage 210, the controller can read a thermostat control signal. The controller can likewise receive IAQ and OAQ information at stages 215 and 220.

Using these inputs, the controller can make an air quality comparison at stage 225. The air quality comparison can be an indoor versus outdoor comparison of pollution levels, VOC levels, temperature, pressure, humidity, and dewpoint. The controller can also consider the HVAC operational state at stage 230, such as whether the fan is on and the HVAC is cooling or heating. Based on if the outdoor-to-indoor temperature difference is within a threshold level for the respective operational state, the HVAC can issue commands to use or disuse outdoor air.

At stage 245, the controller can determine that OAQ is greater than IAQ. This would favor using outdoor air as an intake. If the outdoor air also falls within a threshold difference from the indoor air and/or the temperature of the thermostat, then the controller can issue a first damper command at stage 250. The first damper command can close an inside damper and open an outside damper, causing the HVAC to use outdoor air as an intake.

At stage 255, the controller can determine that OAQ is less than IAQ. The controller can issue a second command at stage 260, causing the indoor damper to open and the outside damper to close. This can switch the HVAC to an indoor air intake. For example, if it begins raining heavily outside, this switch could occur to prevent excess humidity in the HVAC system.

At stage 265, the controller can determine than indoor air temperature (“IAT”) can be compared against outside air dewpoint (“ODP”). ODP can be calculated as shown in Equation 1, below.

$$ODP = \{ [ ( {( \frac{Outside Humidity}{100} )}^{0.125} * ( 17 \; 2.8 + 0.9 * Outside Temperature ) ] + ( 0.1 * Outside Temperature ) - 172.8 \} \qquad Equation 1$$

When IAT is less than ODP and there is a heating call as a current operational state, the controller can issue a damper command at stage 270. This can cause the inside damper to open and the outside damper to close.

In addition, the damper commands can include interrupts. For example, if the current operational state is cool and outdoor air temperature (“OAT”) is less than indoor air temperature (“IAT”) at stage 275, the first command of stage 250 can include an interrupt at stage 280. The interrupt can save the HVAC from continuing to cool while instead relying on the cooler outside air. Similarly, if at stage 285 the operational state is heating and the OAT is greater than IAT, the first command of stage 250 can include an interrupt at stage 290 to stop the HVAC from heating, instead relying on the warmer outside air.

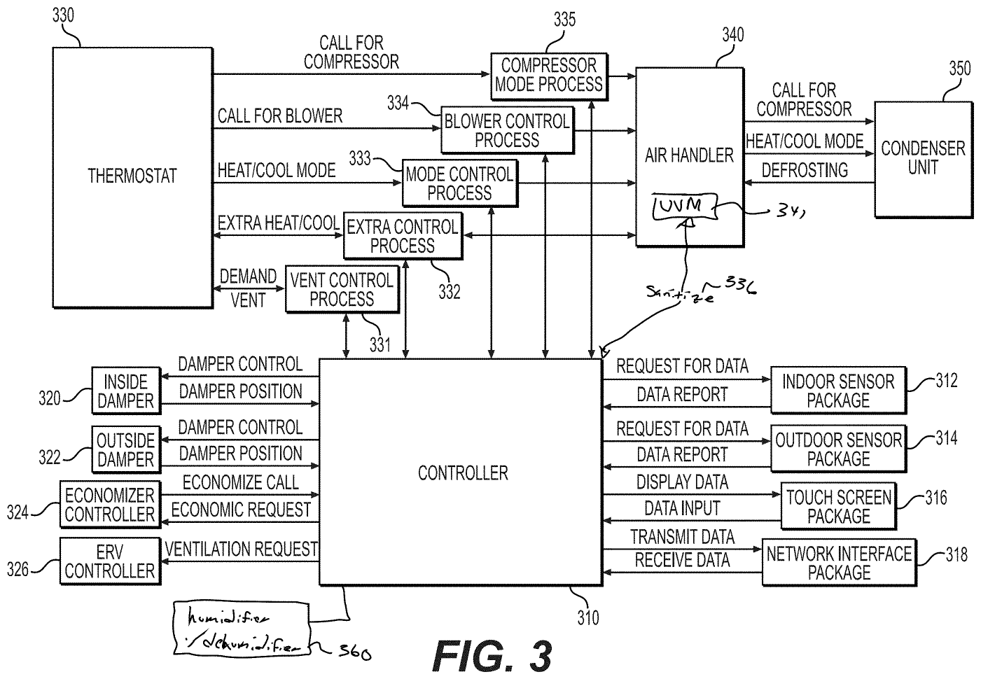

FIG. 3 illustrates example system components. The system can include a plastic box, where the Main Controller, buffer boards, wireless communications interface board, noise sensor, and relay board reside. The noise sensor can include a microphone usable by the controller for detecting sirens and other noise pollution. The plastic box can contain the display unit, such as touch screen module 316 and associated components, and two cylindrical plastic tubes where the air sensor arrays are housed. The touch screen module 316 can provide the options of Table 1, below, in an example.

TABLE 1
Display Indoor Air Quality by category (VOC, CO, CO2, NO, SO,
Particulate)
Display Radon (if enhanced indoor air quality sensor present)
Display Indoor Air Temp, Humidity and Dew Point
Display Outdoor Air Quality by category (VOC, CO, CO2, NO, SO,
Particulate)
Display Outdoor Air Temp, Humidity and Dew Point
Graph Indoor and Outdoor Temp, Humidity, Dew Point and Air Quality
Parameters over time
Pause/Activate/Deactivate Timed Manual Demand Ventilation
Pause/Activate/Deactivate Automated Outdoor Air Ventilation
Set-Up and Update of Installation Parameters including Building Square
Footage, Number of Bedrooms, Air Handler Fan CFM, Sensor Types and
wireless communications interface set-up.

The system can use a noise sensor and audio detection algorithm to determine if a smoke detector, and/or carbon monoxide detector siren is sounding, and if outside air quality is not significantly worse than inside air quality, the system can command the dampers to allow outside air into the building, prevent the recirculation of inside air by the air handler, and signal the air handler blower to activate (i.e., fan=ON). This smoke exhaust ventilation is designed to increase escape and survival times during emergencies by pushing outdoor air into sleeping rooms and forcing toxic gasses and smoke out of the building through passive dampers that can be installed in the common area.

The Main Controller Unit of the system can be accessed by multiple connecton terminals wired into an existing HVAC system and air sensor units. Wiring from the thermostat can be connected to a portion of the Main Controller Unit connection terminals using commercial off-the-shelf (COTS) six-wire or eight-wire thermostat cable. Wiring from the air-handler can connect to another portion of the Main Controller Unit connection terminals using a COTS six-wire or eight-wire thermostat cable. The air sensor units, display unit, evaporator coil sensors and current sensors can each have a four-wire connection terminal to connect to the Main Controller Unit connection terminals using a COTS shielded four-conductor cable.

The system can also include components for buffering between the Controller and HVAC system. Since an HVAC system typically uses 24-volt AC and the Main Controller uses DC voltage to operate, buffering between the two environments can be handled via a custom circuit—one circuit per HVAC line required to be monitored. In one example, the system detects the presence of 24-volt AC on a control line. For example, an optical isolator (opto-isolator) can be used to allow for this detection without imposing a burden onto the HVAC system. Resistors on the AC side allow for the opto-isolator to interface with the HVAC system while resistors and capacitors on the DC voltage side allow for a stead output dependent on the state of the monitored HVAC line. The output on the DC voltage side can be tied to an input on the processor board so the system can read the output state.

In another example, a system allows the Main Controller Unit to be installed within the air-handler housing of a new or pre-existing HVAC system and wired between the thermostat wiring cables and air-handler wiring terminals. Alternatively, the Main Controller Unit may be mounted anywhere between the thermostat and the air handler where the unit can be wired to the thermostat and air handler. Sensor units can be installed at the entrance of the outside air intake duct and in the indoor air return duct. The optional display unit can be installed on the outside of the air handler of any location chosen by the installer, and/or user at a distance from the controller 310.

For example, as frequently as twelve times an hour and every time there is a “fan on” signal 334 from the thermostat 330, the controller 310 can send requests for data to the remote sensor packages 312, 314. The sensor packages 312, 314 can respond with the latest measurements captured. The controller 310 can use the sensor information to compare IAQ and OAQ. When a “fan on” signal is received from the thermostat 330, the controller 310 can determine if the air quality of the outside air is better than the inside air by evaluating quantity of air-borne contaminates.

If the outside air quality is better than inside air quality, the controller 310 can command dampers 320, 322 to allow outside air into the building. This can also include controlling an economizer or energy recovery ventilator (“ERV”) by sending commands to those respective controllers 324, 326. If the controller 310 determines that the outside air quality is not better than inside air quality, the controller 310 can command dampers to prevent the outside air from entering into building. Additionally, if an ERV is present and the outside air quality is better than inside air quality, the controller 310 can activate the ERV to ventilate the building.

Simultaneously, when a “fan on” signal 334 is received from the thermostat 330, the controller 310 can determine if the temperature and humidity of outside air is appropriate for whole building fan cooling/heating by determining if IAT is greater than ODP. ODP can be calculated using Equation 1, above.

Regardless of whether the thermostat signals a cooling call or a heating call 333, if the controller 310 determines that the outside air temperature and/or humidity is not appropriate for whole building fan cooling/heating, the controller 310 can command dampers to not allow the outside air into building.

If the thermostat signals a cooling call 332, 333 and outside air temperature and humidity is appropriate for whole building fan cooling/heating and the outside temperature is less than the inside air temperature and outside air quality is better than inside air quality, the controller 310 can command dampers to allow outside air into the building. The controller 310 can interrupt the cooling call 332, 333, instead relying on outside air for cooling. This can also include overriding a thermostat's ventilation call 331, which may specify a conflicting damper configuration. The controller 310 can also interrupt the call to the compressor 335, relieving the condenser unit 350 from its duties. This can allow the air handler 340 to continue to heat or cool, but do so using the outside air, which can be at an advantageous temperature.

If the thermostat signals a heating call 332, 333, OAT and ODP meet threshold levels (i.e., humidity is appropriate for whole building fan cooling/heating), OAT is greater than the IAT, and OAQ is better than IAQ, the controller 310 can command dampers to allow outside air into the building. The controller 310 can also interrupt the heating call.

Additionally, if an economizer is present, the controller 310 can look to the input of this device to determine if OAT and humidity are at threshold levels appropriate for whole building fan cooling/heating when the thermostat signals a cooling call or heating call.

When an economizer is present, the system can use the Economizer to determine the enthalpy of the outside and inside air. With this information from the Economizer, the Control System can better assess the appropriateness of using outside air to cool or heat the inside of the building thus leveraging the capability of multiple sensor systems and enthalpy comparators to maximize energy efficiency of the HVAC system. When an Energy Recovery Ventilator is present, the control system controls the ERV to recover energy by exchanging (recycling) the energy contained in inside air to be exhausted from a building and using it to treat the incoming outdoor ventilation air in order to achieve energy efficiency improvements in residential and commercial HVAC systems.

When temperature needs have been met and the thermostat 330 removes the call to heat or cool, the blower 340, and compressor 350, will shut down and the controller 310 will await further commands from the thermostat.

The controller 310, can also continuously monitor outdoor air ventilation time to ensure ASHRAE 62.2 ventilation requirements are met based on a rotating 24-hour period. In one example, this is done based on Equation 2, below.

$$Ventilation Requirement ( mins ) = \frac{\{ [ \begin{matrix}( \frac{Building Square Footage}{100} ) + \\ ( \# Bedrooms + 1 ) * 7.5\end{matrix} ] * 1440 \}}{Air Handler Fan CFM} \qquad Equation 2$$

Regardless of cooling call or heating call 333, if ASHRAE 62.2 ventilation requirements have not been met for the preceding 24 hours and outdoor air quality is better than indoor air quality based on combined sensors, the Control System will command dampers to allow outside air into the building on all “fan on” signals 334, until ASHRAE 62.2 ventilation requirements are met for the preceding 24 hours.

If ASHRAE 62.2 ventilation requirements have not been met for the preceding 24 hours and outdoor air quality is not better than indoor air quality based on combined sensors, the controller 310 can command dampers to not allow outside air into the building. If an energy recovery ventilator is present and ASHRAE 62.2 ventilation requirements have not been met for the preceding 24 hours and the outside air quality is better than inside air quality, the Control System will activate the ERV to ventilate the building, until ASHRAE 62.2 ventilation requirements are met for the preceding 24 hours.

The controller 310 can also continuously monitor indoor air sensors to ensure dilutional ventilation requirements to minimize spread of air borne contagions are met. The monitoring can be done based on a rotating 60-minute period. In one example, this is done based on Equation 3, below.

IA_{CO2} ppm>OA_{CO2} ppm+(2343.75/n) Equation 3

In one example, regardless of cooling call or heating call 333, if dilutional ventilation requirements have not been met for the preceding 60 minutes and outdoor air quality is better than indoor air quality based on combined sensors, the controller 310 can command dampers to allow outside air into the building on all “fan on” signals 334. The controller 310 can maintain this state until dilutional ventilation requirements are met for the preceding 60 minutes.

If dilutional ventilation requirements have not been met for the preceding 60 minutes and outdoor air quality is not better than indoor air quality based on combined sensors, the controller 310 can command dampers to allow a minimal fraction of outside air into the building to meet dilutional ventilation requirements. For example, the controller 310 can partially open the outside damper and partially close the inside damper, allowing a mix of air for the air intake.

If an energy recovery ventilator is present and dilutional ventilation requirements have not been met for the preceding 60 minutes, the controller 310 can activate the ERV to ventilate the building, until the dilutional ventilation requirements are met for the preceding 60 minutes, regardless of whether or not the outside air quality is better than inside air quality.

The system can include a network interface 318 for controlling the system over a network, such as a local network or using an app from over the internet.

In one example, the controller 310 can also activate an ultraviolet sanitizer module (“UVM”) 341 that sanitizes the evaporator coils of the air handler. The UV sanitizer module 341 can be powered by a 240V A/C source in one example. The UV sanitizer module 341 can include two or three UV sanitizer illumination panels positioned inside the air handler to sanitize the surfaces of the evaporator coil, drip pan and air handler walls.

The UV sanitizer module can be attached to an air handler 340, which may be part of the HVAC system. The air handler 340 can be part of any type of air conditioning system, such as a heat pump system. The controller 310 can be located indoors on or inside the air handler unit 340, in various examples. UV sanitizer illumination panels can be mounted inside the air handler 340 above and below the evaporator coil(s). A safety switch can be located at the access panel to deenergize the UV sanitizer illumination panel when the air handler access panel is open.

The controller 310 can selectively sanitize the evaporator coils using the UV sanitizer module 341. First, the controller can detect that the air handler 340 fan is on. This can be based on current sensor information from one or more sensors or on the detection of a “fan on” signal from the thermostat. As will be described, the controller can control the UV sanitizer module 341. Next, the controller can detect that the air handler 340 access panel is closed. In one example, there can be a safety switch that signals the controller that the access panel is closed. Then, the controller can energize the UV sanitizer 341 illumination panels. The controller 310 can energize the UV sanitizer module 341 by sending a sanitation signal 336, in an example.

This process can continue indefinitely, generating substantial operational safety for the building occupants served by the HVAC system while avoiding issues related to excess moisture at the air handler and ducts.

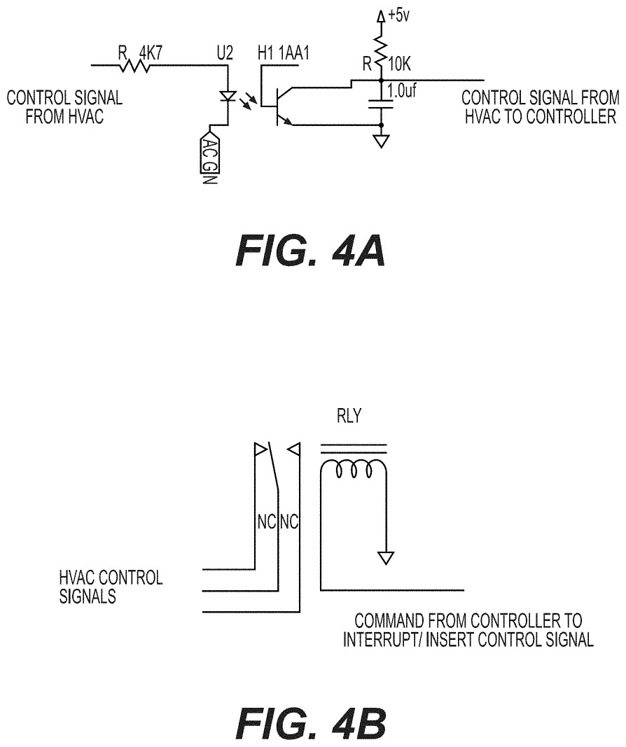

FIG. 4A includes an example schematic for detecting a control signal from an HVAC system at a controller. This is an example opto-isolator configuration but other configurations are possible. FIG. 4B includes an example schematic for interrupting a signal to the HVAC system based on the controller determining to use outdoor air without a need for additional cooling or heating by the HVAC system. However, any other control interrupt, including one without a relay board, is also possible.

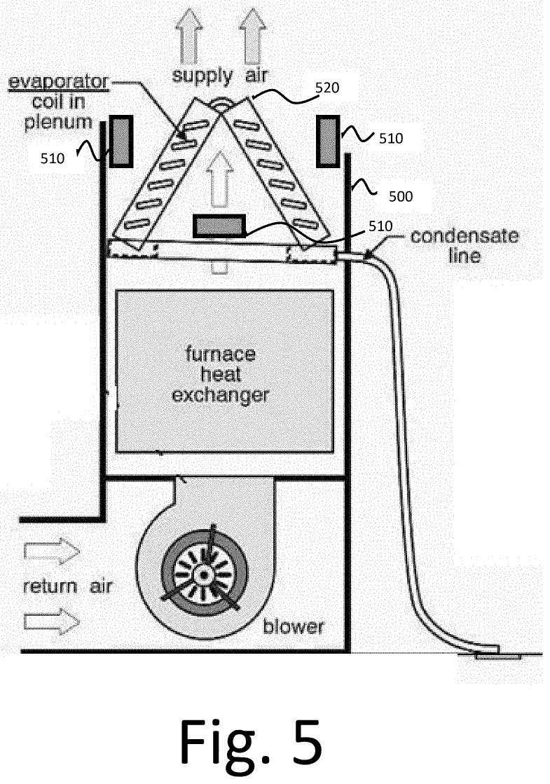

FIG. 5 is an example illustration of an air handler unit 500 equipped with UV sanitizer illumination panel components 510. In one example, UV sanitizer 341 illumination panels 510 are mounted to the air handler unit 500 above and below the evaporator coil unit 520.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The orders of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A dynamic ventilation control system comprising:
an indoor sensor package;
an outdoor sensor package; and
a controller communicatively coupled to the indoor and outdoor sensor packages, wherein the controller performs stages comprising:
receiving indoor air quality (“IAQ”) information from the indoor sensor package and outdoor air quality (“OAQ”) information from the outdoor sensor package;
making an air quality comparison based on the IAQ and OAQ information;
receiving a current operational state of a heating, ventilation, and air conditioning (“HVAC”) system, wherein the operational state includes at least one of heating and cooling; and
generating a first damper command to close an indoor damper and open an outdoor damper of a building, wherein the first damper command is based on at least the air quality comparison favoring OAQ over IAQ and an outside air dewpoint being below indoor air temperature.

2. The system of claim 1, further comprising an opto-isolator that detects a voltage on a control line of the HVAC system, wherein the opto-isolator supplies a lower voltage to the controller when voltage on the control line is present, wherein the stages further comprise:
based on comparing outdoor and indoor air temperatures, interrupting supply of voltage to the HVAC system on the control line, turning off at least one of a compressor and a blower, wherein the interruption includes deactivating a relay switch for the control line.

3. The system of claim 1, wherein the outside air dewpoint is determined based on outside humidity and outside temperature, and wherein the stages further comprise:
generating a second damper command to open the indoor damper and close the outdoor damper, wherein the second damper command is based on the outside air dewpoint being greater than the indoor air temperature, and wherein closing the outside damper substantially disallows outside air from entering the building through the outside damper.

4. The system of claim 1, the stages further comprising:
detecting, with a noise sensor and audio detection algorithm, a siren indicating the presence of smoke or carbon monoxide; and
based on the siren detection, opening the outside damper and closing the inside damper for smoke exhaust ventilation of a building.

5. The system of claim 1, wherein the first damper command also is based on comparing IAQ and OAQ information with an economizer to determine respective energy levels of the indoor and outdoor air, wherein the first damper command activates an energy recovery ventilator to by exchanging inside air to be exhausted from a building with incoming outdoor ventilation air.

6. The system of claim 1, the stages further comprising:
generating an additional damper command to interrupt a heating call from the HVAC system and open the outside damper, wherein the additional damper command is based on at least: the current operational state being heating, the indoor air temperature exceeding outdoor dewpoint, an outside air temperature exceeding indoor air temperature, and OAQ being greater than IAQ.

7. The system of claim 1, the stages further comprising:
storing sensor information including IAQ information, OAQ information, indoor noise pollution (“INP”) information from an indoor sensor package, outdoor noise pollution (“ONP”) information from an outdoor sensor package; and water pollution (“WP”) information from a water sensor package; and
uploading sensor information to a server for use in determining social health.

8. A method for whole-building dynamic ventilation control, comprising:
receiving, at a controller, indoor air quality (“IAQ”) information from the indoor sensor package and outdoor air quality (“OAQ”) information from the outdoor sensor package;
making an air quality comparison based on the IAQ and OAQ information;
receiving a current operational state of a heating, ventilation, and air conditioning (“HVAC”) system, wherein the operational state includes at least one of heating and cooling; and
generating a first damper command to close an indoor damper and open an outdoor damper of a building, wherein the first damper command is based on at least the air quality comparison favoring OAQ over IAQ and an outside air dewpoint being below indoor air temperature.

9. The method of claim 8, further comprising:
detecting, with an opto-isolator, a voltage on a control line of the HVAC system;
supplying a lower voltage to the controller when the voltage is present on the control line; and
interrupting supply of the voltage to the HVAC system on the control line, turning off at least one of a compressor or blower, wherein the interruption includes deactivating a relay switch for the control line.

10. The method of claim 8, wherein the outside air dewpoint is determined based on outside humidity and outside temperature, the method further comprising:
generating a second damper command to open the indoor damper and close the outdoor damper, wherein the second damper command is based on the outside air dewpoint being greater than the indoor air temperature, and wherein closing the outside damper substantially disallows outside air from entering the building through the outside damper.

11. The method of claim 8, further comprising:
detecting, with a noise sensor and audio detection algorithm, a siren indicating the presence of smoke or carbon monoxide; and
based on the siren detection, opening the outside damper and closing the inside damper for smoke exhaust ventilation of a building.

12. The method of claim 8, wherein the first damper command also is based on comparing IAQ and OAQ information with an economizer to determine respective energy levels of the indoor and outdoor air, wherein the first damper command activates an energy recovery ventilator to by exchanging inside air to be exhausted from a building with incoming outdoor ventilation air.

13. The method of claim 8, further comprising:
generating an additional damper command to interrupt a heating call from the HVAC system and open the outside damper, wherein the additional command is based on at least: the current operational state being heating, the indoor air temperature exceeding outdoor dewpoint, an outside air temperature exceeding indoor air temperature, and OAQ being greater than IAQ.

14. The method of claim 8, further comprising:
receiving inputs regarding a building square footage and number of bedrooms and/or maximum permitted number of occupants;
determining a ventilation requirement based on the inputs; and
when the ventilation requirement is unmet for a time interval and the HVAC system fan is on, partially opening the outside damper and partially closing the inside damper.

15. A non-transitory, computer-readable medium containing including instructions to a dynamic ventilation control system, the instructions being executed by a controller to perform stages comprising:
receiving, at a controller, indoor air quality (“IAQ”) information from the indoor sensor package and outdoor air quality (“OAQ”) information from the outdoor sensor package;
making an air quality comparison based on the IAQ and OAQ information;
receiving a current operational state of a heating, ventilation, and air conditioning (“HVAC”) system, wherein the operational state includes at least one of heating and cooling; and
generating a first damper command to close an indoor damper and open an outdoor damper of a building, wherein the first damper command is based on at least the air quality comparison favoring OAQ over IAQ and an outside air dewpoint being below indoor air temperature.

16. The non-transitory, computer-readable medium of claim 15, the stages further comprising:
detecting, with an opto-isolator, a voltage on a control line of the HVAC system;
supplying a lower voltage to the controller when the voltage is present on the control line; and
interrupting supply of the voltage to the HVAC system on the control line, turning off at least one of a compressor or blower, wherein the interruption includes making a state change to a switch for the control line.

17. The non-transitory, computer-readable medium of claim 15, wherein the outside air dewpoint is determined based on outside humidity and outside temperature, the stages further comprising:
generating a second damper command to open the indoor damper and close the outdoor damper, wherein the second damper command is based on the outside air dewpoint being greater than the indoor air temperature, and wherein closing the outside damper substantially disallows outside air from entering the building through the outside damper.

18. The non-transitory, computer-readable medium of claim 15, the stages further comprising:
detecting, with a noise sensor and audio detection algorithm, a siren indicating the presence of smoke or carbon monoxide; and
based on the siren detection, opening the outside damper and closing the inside damper for smoke exhaust ventilation of a building.

19. The non-transitory, computer-readable medium of claim 15, wherein the first damper command also is based on comparing IAQ and OAQ information with an economizer to determine respective energy levels of the indoor and outdoor air, wherein the first damper command activates an energy recovery ventilator to by exchanging inside air to be exhausted from a building with incoming outdoor ventilation air.

20. The non-transitory, computer-readable medium of claim 15, the stages further comprising:
generating an additional damper command to interrupt a heating call from the HVAC system and open the outside damper, wherein the additional damper command is based on at least: the current operational state being heating, the indoor air temperature exceeding outdoor dewpoint, an outside air temperature exceeding indoor air temperature, and OAQ being greater than IAQ.
